(19) United States
(12) Patent Application Publication
(10) Pub. No.: US 2005/0061118 A1
(43) Pub. Date: Mar. 24, 2005

(54) 90 angle clamping pliers

(76) Inventor: John Morgan Heacock, Shepherdsville, KY (US)

Correspondence Address: JOHN MORGAN HEACOCK, 229 LAZY RIVER NORTH PARKWAY, SHEPHERDSVILLE, KY, 40165, US

(21) Appl. No.: 10/668,886

(22) Filed: Sep. 22, 2003

(51) Int. Cl. B25B 7/02

(52) U.S. Cl. 81/420

(57) ABSTRACT

A 90° angle clamping plier is provided, having a handle portion which includes an adjustable, lockable, clamping mechanism, operably connected to two arms. Each arm includes an end portion and a medial portion. Pivotally secured to the end portions of each arm is a clamping jaw. The two clamping jaws form a constant angular relationship with respect to each other. The invention is so designed that when the handle portion is gripped, the clamping jaws move toward each other so as to meet and engage planar work pieces there between at a 90° angled relationship. Once the work pieces are clamped between the clamping jaws, they may be locked in such position by the locking mechanism in the handle portion of the device.

### FEDERALLY SPONSORED RESEARCH

Not Applicable

### SEQUENCE LISTING OR PROGRAM

Not Applicable

### TECHNICAL FIELD

This invention relates to the field of hand tools such as pliers and clamps. More particularly, it relates to a lockable clamping plier for securing a plurality of work pieces, such as two pieces of metal, together.

### BACKGROUND OF THE INVENTION

The field of endeavor to which this invention pertains is the skilled trades.

A specific problem relating to this field has been the inability to rigidly secure two pieces of material together quickly and precisely at a 90° angled relationship.

While a wide variety of clamping tools have been developed, which include many different types of clamping systems that perform a variety of functions, none are adapted to quickly and rigidly securing a plurality of work pieces together in a precise 90° angled relationship.

It is often necessary in the construction or industrial trades to secure two pieces of heavy material together rigidly at a precise 90° angle, so that they may be permanently secured at said relationship.

For example, in metalworking it is often necessary to secure two pieces of heavy metal together at a precise 90° angle, so that they can be permanently welded together.

Likewise, the securing together of materials in a quick, rigid and precise 90° angled relationship is important in a variety of the skilled trade fields.

Thus, a need exists for a tool capable of not only quickly and precisely, but also rigidly securing two pieces of material together at a 90° angle, so that such material can be permanently bonded together.

The present invention, the “90° angle clamping pliers” satisfies all of these needs.

### SUMMARY OF THE INVENTION

It is an object of the present invention to provide an angle clamping tool usable to secure a plurality or work pieces together in a precise 90° angled relationship.

It is another object of the present invention to provide an angle clamping tool capable of rigidly securing a plurality of work pieces together in said angled relationship, so the work pieces may be easily worked on.

It is an even further object of the present invention to provide an angle clamping tool which includes a locking system for maintaining said work in said angled relationships

To accomplish these objectives, the present invention utilizes its two angled jaws, which provide the capability of clamping materials rigidly at a precise 90° angled relationship, while the handle portion allows for rapid and easy operation of the lockable clamping action.

### DRAWINGS

Drawing Figures

FIG. 1 is a perspective view of the present invention.

FIG. 2 is a perspective view of the upper and lower jaws of the present invention

FIG. 3 is a front elevational view of the upper and lower jaws of the present invention.

FIG. 4 is a side elevational view of the handle portion of the present invention.

### REFERENCE NUMERALS IN DRAWINGS

5 present invention
6 handle portion
7 upper jaw
8 lower jaw
9 attachment hole/pivotal point for upper jaw
10 attachment hole/pivotal point for lower jaw
11 upper handle member
12 lower handle/locking member
13 upper arm
14 lower arm
15 medial portion of upper arm
16 medial portion of lower arm
17 end portion of upper arm
18 end portion of lower arm
19 locking/release lever
20 toggle link
21 threaded adjusting screw
22 threaded opening in upper handle member
23 anchoring point for tension spring
24 anchoring point for tension spring
25 tension spring
26 pivotal point for upper and lower arms
27 pivotal point for lower handle/locking member
28 pivotal point for toggle link
29 pivotal point for locking release level
30 attachment hole/pivotal point for upper jaw
31 attachment hole/pivotal point for lower jaw

### DETAILED DESCRIPTION OF THE INVENTION

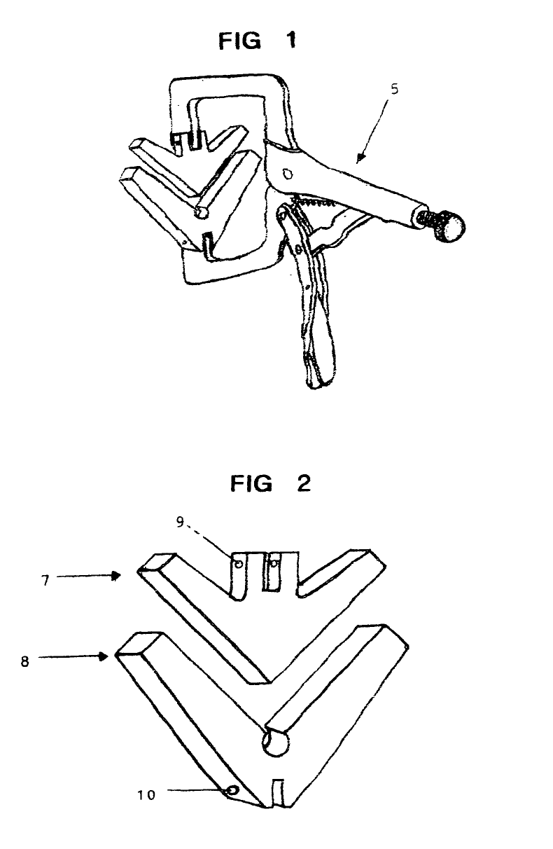

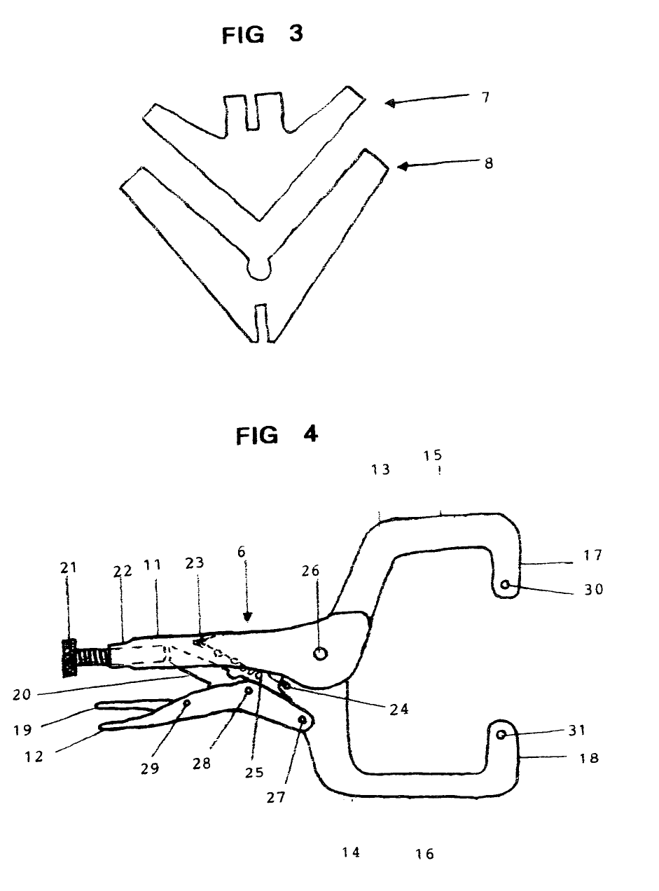

The present invention 5 represents an improved clamping tool specially designed to engage and retain work pieces at a 90° angled relationship. As shown in FIG. 1 and/or 4 of drawings, the invention 5 includes as its major components a handle portion 6 with pivotally secured upper and lower arms 13,14. Pivotally secured to the end portions 17,18 of the upper and lower arms 13,14 are the upper and lower jaws 7,8. The handle portion 6 is preferably of the type sold by the Peterson Manufacturing Company of DeWitt, Nebr. under the registered trademark Vice Grip.

The individual components of the present invention 5, shown in either FIGS. 1 or 4 function as follows: when the locking release lever 19, which pivots at 29, is pressed downward away from the upper handle member 1 it causes the tension spring 25, which is anchored at 23,24 to urge the upper and lower arms 13,14 to pivot at 26 into an open position. When the threaded adjusting screw 21, which is threadably disposed to the threaded opening in the upper handle member 22, is turned either clockwise for tightening or counterclockwise for loosening, it forces the toggle link 20, which pivots at 28, to force the lower handle/locking member 12, which pivots at 27, to force the upper and lower arms 13,14 to pivot at 26, which in turn cause the upper and lower arms 13,14 to either move away from each other in an open position or move toward each other in an closed position. The upper and lower arms 13,14 are designed so that their medial portions 15,16 are sufficiently spaced as to allow passage of the work pieces therebetween, pivotally secured to the end portions 17,18 of the upper and lower arms 13, 14 are the upper and lower jaws 7,8 at the pivot points 9,10.

For the operation of the present invention 5, you would first press the locking release lever 19 downward causing the upper and lower jaws, 7,8 to open away from each other. Next you would place the work pieces between the upper and lower jaws 7,8 once the work pieces are placed as desired between the upper and lower jaws 7,8 the lower handle/locking member 12 and the upper handle member 11 are squeezed toward each other, causing the upper and lower jaws 7,8 to move inwardly toward each other, due to pivot points 9,10 upper and lower jaws 7,8 stay at a constant angled relationship regardless of thickness of work pieces, as a result, the longitudinal gripping sides of the upper and lower jaws 7,8 come into abutting engagement with the work pieces. Through the known action of the described components in the handle portion 6. The work pieces are then locked into position. The thickness of the work pieces will determine the amount of adjustment needed by the threaded adjusting screw 21.

While the process of making the present invention 5, could be accomplished by several manufacturing processes, I choose to make the prototype of the present invention by machine methods using a vertical milling machine. By modifying the end portion 17,18 of the upper and lower arms 13,14 of the existing locking C-clamp pliers of the before mentioned brand, and pivotally attaching a set of upper and lower jaws 7,8 which were machined from a medium carbon steel material having a carbon range percentage of 0.80, which is equivalent to Rockwell 16 C. While maintaining a surface finish of RA-0.80 microns per inch. While also maintaining a finished thickness which would refrain the upper and lower jaws 7,8 from flexing.

While but one embodiment of the invention has been described and shown herein, it will be apparent to those skilled in the art that the invention may be varied. Without departing from the spirit and scope of the invention as defined in the following claims.

1. In a clamping tool having a handle portion in association with a locking mechanism, the improvement comprising: pivotally movable upper and lower arms extending outwardly from said handle portion; with an upper jaw pivotally secured to said upper arm and a lower jaw pivotally secured to said lower arm, so as to be positioned at an angled relationship with respect to each other, so as to engage planar work pieces therebetween at a 90° angled relationship.

2. The clamping tool of claim 1 wherein said upper and lower arms comprise end portions to which said upper and lower jaws are pivotally secured, and medial portions between said end portions and said handle portion.
